(19) United States
(12) Patent Application Publication
(10) Pub. No.: US 2016/0005527 A1
(43) Pub. Date: Jan. 7, 2016

(54) COIL UNIT FOR THIN FILM INDUCTOR, MANUFACTURING METHOD OF COIL UNIT FOR THIN FILM INDUCTOR, THIN FILM INDUCTOR AND MANUFACTURING METHOD OF THIN FILM INDUCTOR

(71) Applicant: SAMSUNG ELECTRO-MECHANICS CO., LTD., Suwon-Si (KR)

(72) Inventors: Jeong Woo PARK, Suwon-Si (KR); Dong Min KIM, Busan (KR)

(21) Appl. No.: 14/789,713

(22) Filed: Jul. 1, 2015

(30) Foreign Application Priority Data
Jul. 2, 2014 (KR) 10-2014-0082511

(51) Int. Cl. H01F 27/28; C25D 7/00; C25D 5/10; H01F 41/04; C25D 5/12

(52) U.S. Cl. CPC H01F 27/2804; H01F 41/042; C25D 5/12; C25D 5/10; C25D 7/00; H01F 2027/2809

(57) ABSTRACT

A coil unit for the thin film inductor includes an insulating material and a coil pattern. The coil pattern includes an inner plating layer embedded in the insulating layer, a growth conductive layer formed on a surface of the inner plating layer and formed on a top surface and a bottom surface of the insulating layer and an outer plating layer formed on the top surface and the bottom surface of the insulating material by plating and growing based on the growth conductive layer.

### CROSS-REFERENCE TO RELATED APPLICATIONS

Claim and incorporated by reference domestic priority application and foreign priority application as follows:

### CROSS REFERENCE TO RELATED APPLICATION

This application claims the foreign priority benefit under 35 U.S.C. Section 119 of Korean Patent Application Serial No. 10-2014-0082511, entitled filed Jul. 2, 2014, which is hereby incorporated by reference in its entirety into this application.”

### BACKGROUND OF THE INVENTION

1. Field of the Invention

The present invention relates to a coil unit for a thin film inductor, a manufacturing method of a coil unit for a thin film inductor, a thin film inductor and a manufacturing method of a thin film inductor.

2. Description of the Related Art

In recent, the miniaturization and high function of electronic products including a mobile phone have been rapidly progressed due to the development of electronic industry, in this result, it is inevitable that the components used in the electronic products perform a high function with lighter and smaller. Accordingly, even in the field of developing an inductor used in the electronic products, the miniaturization and slimness becomes very critical problems.

According to such trends, as the development of inductor has been focused on the compatibility between the miniaturization and slimness characteristics as well as the high function, the thin film inductor is developed and commercialized as such inductor recently.

The thin film mainly adopts a coil unit forming coil patterns on a top surface and a bottom surface of an insulting substrate until the present time.

However, the coil unit for the thin film inductor as like the above structure becomes thicker in the whole thickness of the coil unit since the coil patterns are formed on the top surface and the bottom surface of the insulating substrate as well as the difficulties are generated in designing the characteristics of the thin film inductor or the like due to the problems such as the dispersion of plating thickness, the short between patterns or the like. In addition, there occurs a problem such as delamination between the pattern on the insulating substrate and the insulating material.

### SUMMARY OF THE INVENTION

The present invention has been invented in order to overcome the above-described problems and it is, therefore, an object of the present invention to provide a coil unit for thin film inductor with a method for manufacturing the coil unit for thin film inductor and a thin film inductor and with a method for manufacturing the thin film inductor that can be miniaturized and thinned and prevent patterns from being delaminated.

And also, it is another object of the present invention to provide a coil unit for thin film inductor with a method for manufacturing the coil unit for thin film inductor and a thin film inductor and with a method for manufacturing the thin film inductor capable of designing the characteristics of the thin film inductor more freely as well as capable of realizing the mass production by simplifying the manufacturing process.

In accordance with one aspect of the present invention to achieve the object, there is provided a coil unit for a thin film inductor, a method for manufacturing a coil unit for a thin film inductor, a thin film inductor and a method for manufacturing a thin film inductor capable of forming a growth conductive layer on the inner plating layer for growing an outer plating layer in the coil pattern including an inner plating layer embedded inside of an insulating material and the outer plating layer formed on a top surface and a bottom surface of the insulating material.

Also, in accordance with another aspect of the present invention to achieve the object, there is provided a coil unit for a thin film inductor, a method for manufacturing a coil unit for a thin film inductor, a thin film inductor and a method for manufacturing a thin film inductor, after circuit patterns are formed on each of the pair of metal layers attached to both surfaces of a base layer by the medium of an adhesive layer, to adopt a process for separating these.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a schematic cross-sectional view of a coil unit for a thin film inductor in accordance with one embodiment of the present invention;

FIG. 2 is a process flowchart of a method for manufacturing a coil unit for a thin film inductor in accordance with another embodiment of the present invention;

FIG. 3 is a schematic cross-sectional view of a carrier used in the method for manufacturing the coil unit in accordance with the embodiment of the present invention;

FIG. 4A and FIG. 4B are cross-sectional views showing a step of forming an inner plating layer of FIG. 2;

FIG. 5 is a cross-sectional view showing a step of separating a metal layer of FIG. 2;

FIG. 6 is a cross-sectional view showing a step of forming the insulating material;

FIG. 7A and FIG. 7B are cross-sectional views showing steps of forming a growth conductive layer of FIG. 2;

FIG. 8A through FIG. 8C are cross-sectional views showing steps of forming an outer plating layer and an insulating resist of FIG. 2; and

FIG. 9 is a schematic cross-sectional view of a thin film inductor in accordance with another embodiment of the present invention.

### DETAILED DESCRIPTION OF EMBODIMENTS

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

The objects, specific advantages, and novel features of the present invention will become more apparent from the following detailed description and preferable embodiments when taken in conjunction with the accompanying drawings. In the specification, in adding reference numerals to elements of each drawing, it is to be noted that like reference numerals like elements even through elements are shown in different drawings. Further, in describing the present invention, a detailed description of related well-known techniques will be omitted so as not to obscure the subject of the present invention. In the specification, the terms “first”, “second”, and so on are used to distinguish between similar elements and do not limit the elements.

### Coil Unit for Thin Film Inductor

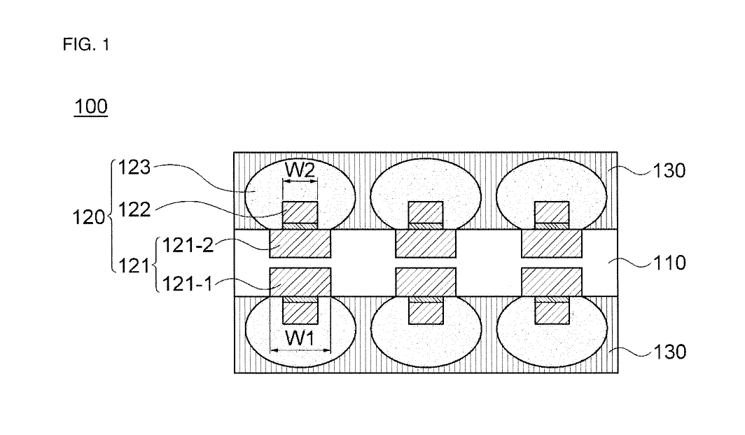

First, FIG. 1 is a schematic cross-sectional view of a coil unit 100 for a thin film inductor in accordance with one embodiment of the present invention;

As shown in FIG. 1, the coil unit 100 for the thin film inductor in accordance with the embodiment of the present invention may include an insulating material 110 and a coil pattern 120.

First, the insulating material 110, as shown in FIG. 1, embeds an inner plating layer 121 of the coil pattern 120 formed from a top surface and a bottom surface of the insulating material 110.

Also, the insulating material 110 in accordance with the embodiment of the present invention may be formed from a mixture of Prepreg (PPG) and resin or formed from a type of resin, but it is not limited thereto. Any substance is possible if it can protect by insulating the inner plating layer 121 embedded therein.

Thus, for the insulating material 110 a variety of applications can be made, such as forming a mixture of at least one or two substances selected from a group of Acrylic polymer, Phenolic polymer, and Polyamide polymer.

Also, the insulating material 110 in accordance with the embodiment of the present invention, as shown in FIG. 1, may be formed in a single insulating layer structure. However, the present invention is not limited thereto. A double insulating layer structure of different substances may be adopted; in this case, an insulating material embedding the inner plating layer 121-1 on the bottom surface and an insulating material embedding the inner plating layer 121-2 on the top surface may be formed of two different substances.

Like the above, if the insulating material with the double insulating layer structure of different substances is adopted, the thickness can be easily adjusted in comparison with a single insulating layer structure, the insulation distance between the coil pattern and a magnetic substance as well as the distance of the coil may be easily adjusted. Accordingly, the capacitance characteristics of the thin film inductor can be designed and formed more freely.

Next, the coil pattern 120, as shown in FIG. 1, may include an inner plating layer 121, a growth conductive layer 122, and an outer plating layer 123.

The inner plating layer 121, as shown in FIG. 1, may be formed by embedding in the insulating material 110.

In case of the embodiment of the present invention, by embedding the inner plating layer 121 of the coil pattern 120 in the insulating material 110, the whole thickness can be minimized in comparison with a coil unit of which the plating layers are formed on a top surface and a bottom surface of the insulating material. Thus, it is possible to achieve miniaturization and slimming of a thin film inductor including this.

Also, the inner plate layer 121 of the coil pattern 120, as shown in FIG. 1, may include a first inner plating layer 121-1 and a second inner plating layer 121-2.

The first inner plating layer 121-1, as shown in FIG. 1, may be formed by embedding from the bottom surface of the insulating material 110.

The second inner plating layer 121-2, as shown in FIG. 1, may be formed by embedding from the top surface of the insulating material 110.

At this time, the first inner plating layer 121-1 and the second inner plating layer 121-2 may be formed by mixing at least one or at least two substances selecting from a group of Copper (Cu), Gold (Au), Silver (Ag), Aluminum (Al), and Nickel (Ni), but it is not limited thereto.

Thus, in the embodiment of the present invention, the first inner plating layer 121-1 and the second inner plating layer 121-2 formed into a single layer is shown as an example, but it is not limited thereto.

Therefore, at least one of the first inner plating layer 121-1 and the second inner plating layer 121-2 may be formed by a plurality of plating layers. When the inner plate layer of the coil pattern is formed by a plurality of plate layers, the cross-sectional area of the coil pattern may be adjusted and formed, this helps to improve the degree of freedom of designing the characteristics of the thin film inductor such as the impedance.

Meanwhile, the coil unit 100 for the thin film inductor in accordance with the embodiment of the present invention may further include a conductive via-hole (not shown) to electrically connects each coil pattern and an outer circuit pattern. That is, inside the insulating material 110, the via-hole is processed through mechanical methods, lasers, or Photo-lithographical processes, with that via-hole, the conductive via-hole can be formed by being plated through a process such as De-smear and chemical copper plating or the like.

Meanwhile, the growth conductive layer 122, as shown in FIG. 1, may be formed on a top surface and a bottom surface of the insulating material 110.

At this time, the growth conductive layer 122, as shown in FIG. 1, the growth conductive layer 122 is formed on the inner plating layer 121 as playing a role of a base electrode in a process such as an electroplating in order for plating and growing the outer plating layer 123 described hereinafter.

In case of the embodiment of the present invention, by forming the growth conductive layer 122 on the inner plating layer 121, as shown in FIG. 1, a bonding of two conductors can be formed across the top surface and the bottom surface of the insulating material 110, these bonding may improve the bonding power of the insulating material and the conductors in comparison with that of a conventional structure. Thus, when the growth conductive layer 122 is formed on the inner plating layer 121 according to the embodiment of the present invention, the pattern delamination between the insulating material 110 and the coil pattern 120 can be prevented.

And also, similar to the embodiment of the present invention, in case when the growth conductive layer 122 is formed on the inner plating layer 121, the conductors are bonded across the top surface and the bottom surface of the insulating material 110, the plating area can be formed more wider, in this result, the degree of freedom of the design in the characteristics such as an impedance or the like of the thin film inductor can be improved.

Meanwhile, in case of the growth conductive layer 122 with the embodiment of the present invention, the width W2 thereof may be smaller than the width W1 of the inner plating layer 121. If the width W2 of the growth conductive layer 122 is larger or equal to the width W1 of the inner plating layer 121, a short circuit may occur between the adjoining outer plating layers 123 when the outer plating layer 123 is formed by anisotropic plating or the like.

However, the present invention is not limited thereto, therefore, when the outer plating layer 123 is formed by anisotropic plating or the like, the width W2 of the growth conductive layer 122 may be larger or equal to the width W1 of the inner plating layer 121.

Meanwhile, the outer plating layer 123, as shown in FIG. 1, may be formed on the top surface and the bottom surface of the insulating material 110, as described above, and is formed by performing the electroplating using the growth conductive layer 122 as a base electrode and growing this.

At this time, the outer plating layer 123, as shown in FIG. 1, may be formed by anisotropic plating, but it is not limited to. The outer plating layer 123 may be formed by unidirectional plating as well as anisotropic plating.

In addition, the coil unit 100 for the thin film inductor in accordance with the embodiment of the present invention, as shown in FIG. 1, can form a solder resist 130 for insulating the top surface and the bottom surface of the insulating material 110 and the outer plating layer 123. However, the present invention is not limited thereto; the solder resist 130 can be formed along the surface of the outer plating layer 123. Also, any insulation resist that can protect the exposed regions of the outer plating layer 123 can be used.

### Method for Manufacturing Coil Unit for Thin Film Inductor

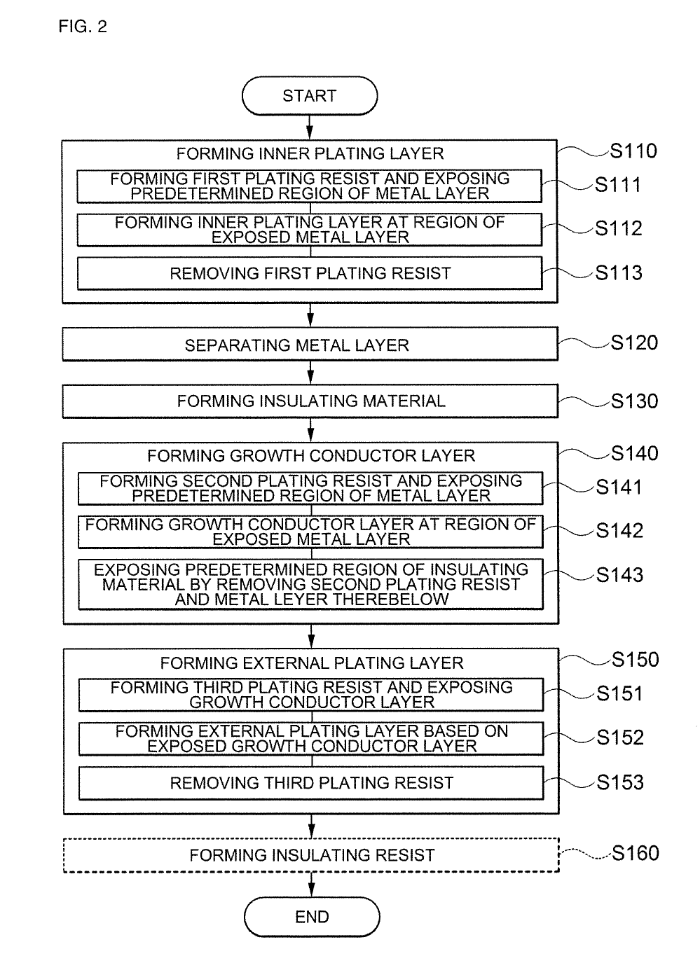

FIG. 2 is a process flowchart of a method for manufacturing a coil unit for a thin film inductor in accordance with another embodiment of the present invention.

Referring to FIG. 2, the method for manufacturing a coil unit for a thin film inductor in accordance with another embodiment of the present invention may include forming an inner plating layer on a pair of metal layers attached on both surfaces of the base layer by an adhesive layer (S110), separating the pair of metal layers from the base layer (S120), forming an insulating material in such a way that the inner plating layers formed on each of the pair of separated metal layers are embedded (S130), forming a growth conductive layer on the inner plating layer (S140) and forming an outer plating layer on a top surface and a bottom surface of the insulating material by plating growing based on the growth conductive layer (S150). In addition, after forming the outer plating layer (S150), the present invention further includes forming an insulating resist (S160).

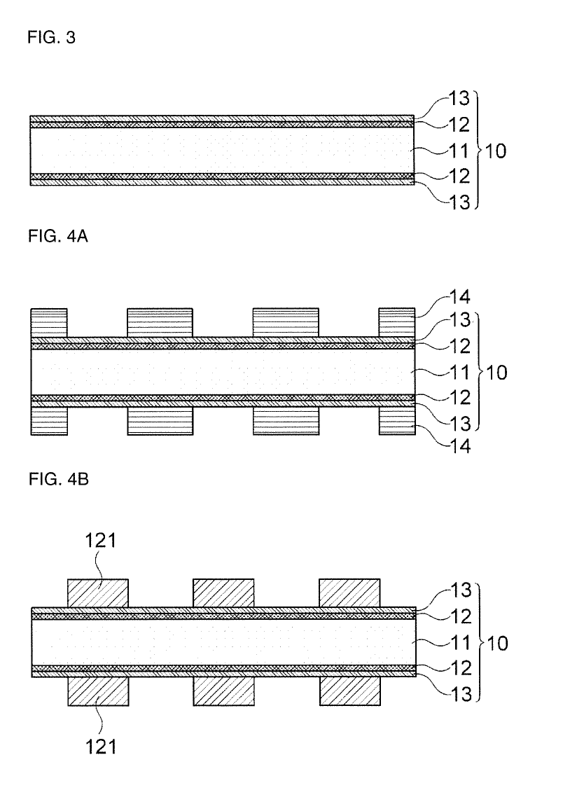

In the embodiment of the present invention, a method for manufacturing a carrier shown in FIG. 3 may be adopted. FIG. 3 shows a schematic cross-sectional view of a carrier used in the method for manufacturing the coil unit in accordance with the embodiment of the present invention.

The method for manufacturing a coil unit for thin film inductor in accordance with the embodiment of the present invention, as shown in FIG. 3, may use a carrier 10 formed by attaching a pair of metal layers 13 on both surfaces of the base layer 11 by the medium of an adhesive layer 12.

At this time, as shown in FIG. 3, the carrier 10 may include the base layer 11, a pair of adhesive layers 12 to be stacked on both surfaces of the base layer 11, and a pair of metal layers 13 to be attached to each of the pair of adhesive layers 12.

The base layer 11 can individually separate the metal layer 13 attached on each adhesive layer 12, respectively, by dividing the adhesive layers 12 formed on both sides of the base layer 11. The base layer 11 may be used as a synthetic resin such as a paper, a felt, polyethylene, polypropylene, polybutylene or the like.

The adhesive layer 12 is stacked on both surfaces of the base layer 11, a predetermined factor weakens the adhesive strength of the adhesive layer, the predetermined factor may be an ultraviolet light or heat.

The metal layer 13, attached on the adhesive layer 12, is stuck to the adhesive layer 12 and can be easily detached from the base layer 11 by weakening the adhesive strength by the predetermined factor.

The property of an adhesive forming the adhesive layer 12 changes by the fixed factor so as to easily detach the metal layer 13 from the base layer 11.

For example, by forming the adhesive layer 12 using an adhesive mixed with a material to generate gas due to the emission of ultraviolet light, the adhesive strength becomes weak by emitting as the optimum of the adhesive layer 12 is changed by generating the gas in the adhesive layer 12.

Also, by forming the adhesive layer 12 using an expandable adhesive mixed with the material to be expanded due to a predetermined heat, if the predetermined heat is applied when the adhesive layer 12 is to be separated, the expansion occurs inside of the adhesive layer 12. In this result, the adhesive property is degraded while the adhesive surface becomes uneven.

The metal layer 13 is attached on the base layer 11 and the adhesive layer 12; but, if needed, the metal layer 13 may be detached from the base layer 11.

For instance, in accordance with the embodiment of the present invention, an embossed circuit pattern is formed on any one metal layer of the pair of metal layers 13, after an embossed circuit pattern is formed on the other metal layer, if the pair of metal layers 13 are separated from the base layer 11, two metal layers 13 formed thereon the embossed circuit patterns 13 can be formed at once. At this time, if the insulating material is stacked and formed so as to embed the embossed circuit patterns, the composition (a first inner plating layer and a second inner plating layer in the embodiment of the present invention) of coil pattern embedded in the insulating material may be formed.

The embodiment of the present invention adopts the process to use the carrier 10, more specifically, after forming the circuit pattern on each of the metal layer 13 of the carrier 10, each of the metal layers 13 formed with the circuit pattern is separated, respectively, thus simplifying its manufacturing process to enable mass production.

Meanwhile, the metal layer 13 can be separated from the base layer 11 by weakening the adhesive strength of the adhesive layer 12 interposed between the base layer 11 and the metal layer 13. That is, the metal layer 13 can be detached from the base layer 11 when the adhesive strength is weakened by applying the predetermined factor.

The metal layer 13 may be formed of conductive metal, in this case, although the conductive metal can be at least one substance selecting from a group of Copper (Cu), Gold (Au), Silver (Ag), Aluminum (Al), Nickel (Ni), Palladium (Pd), and Platinum (Pt). However, it is not limited thereto, and various applications including forming the metal layer 13 out of one metal from above and forming the metal layer 13 with a combination of the above metals are allowable.

As the following drawings are process diagrams showing a method for manufacturing a coil unit for a thin film inductor in accordance with an embodiment of the present invention, each step of the manufacturing method is described in detail through the following drawings.

First, FIG. 4A and FIG. 4B are cross-sectional views showing a step S110 of forming an inner plating layer of FIG. 2.

As shown in FIG. 2, FIG. 4A and FIG. 4B, the step S110 of forming the inner plating layer in accordance with the embodiment of the present invention may include exposing a predetermined region of the metal layer by forming a first plating resist corresponding to the inner plating layer on each of the pair of metal layers (S111), forming the inner plating layer on the region of the metal layer exposed in the step S111 (S112) and removing the first plating resist formed in the step S111 (S113).

The step S110 of forming the inner plating layer in accordance with the present invention may be described more specifically by first, as shown in FIG. 4A, forming the first plating resist 14 which corresponds to the first plating layer on the pair of the metal layers 13 of the carrier 10, the predetermined region (inner plating layer) of the metal layer 13 cab be exposed (S111).

At this time, as the first plating resist 14, although a Dry Film Resist may be used, but it is not limited thereto, any type of resist pattern to form a plating layer for the coil pattern such as a photoresist can be used.

Furthermore, as shown in FIG. 4B, the inner plating layer 121 can be formed (S112) by filling the exposed area (area of the metal layer where the first plating resist has not formed) of the pair of metal layers 13 in the step S111 with a conductive material by performing electroplating using the metal layer 13 as an electrode.

Also, by removing the first plating resist 14 through processes such as exposure and development (S113), the inner plating layer 121 may be formed on each of the pair of metal layers 13, as shown in FIG. 4B.

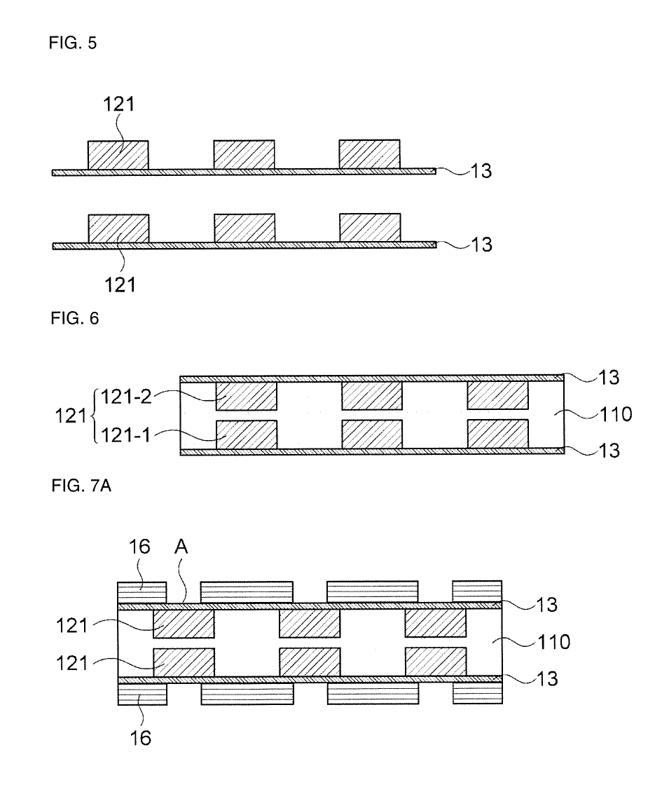

FIG. 5 is a cross-sectional view showing a step S120 of separating the metal layer of FIG. 2

The step S120 of separating the metal layer in accordance with the embodiment of the present invention, as shown in FIG. 2 and FIG. 5, the pair of metal layers of which inner plating layers are formed may be separated from the base layer.

That is, as shown in FIG. 5, in the step S120 of separating the metal layer in accordance with the embodiment, the pair of metal layers 13 of which inner layers are formed can be separated from the base layer, thus able to form two metal layers 13 formed with inner plating layers 121 through one process. Accordingly, the mass production can be allowable by simplifying the manufacturing process.

Also, in the step S120 of separating the metal layer in accordance with the embodiment of the present invention, referring to FIG. 3, since the adhesive layer 12, of which the adhesive strength is deteriorated by the predetermined factor is stacked on both surfaces of the base layer 11 and the metal layers are attached on each adhesive layer 12, the metal layer 13 can be detached after the adhesive strength of the adhesive layer 12 is degraded by applying the predetermined factor to the adhesive layer 12.

In this case, the predetermined factor that weakens the adhesive strength of the adhesive layer 12 may be an ultraviolet light or heat. That is, by forming the adhesive layer 12 using an adhesive mixed with the material to generate gas when an ultraviolet light is irradiated, the adhesive strength can be degraded with changing the optimum of the adhesive layer 12 by irradiating the ultraviolet light. Also, by forming the adhesive layer 12 using an expandable adhesive mixed with the material to be expanded due to a predetermined heat, if the predetermined heat is applied when the adhesive layer 12 is to be separated, the expansion occurs inside of the adhesive layer 12. In this result, the adhesive property is degraded while the adhesive surface becomes uneven.

FIG. 6 is a cross-sectional view showing a step S130 forming the insulating material of FIG. 2.

In the step S130 of forming the insulating material in accordance with the embodiment of the present invention, as shown in FIG. 2 and FIG. 6, the insulating material is formed on the inner plating layer and the metal layer which the first plating resist is removed.

More specifically, in the step S130 of forming the insulating material, the insulating material 110 is interposed and stacked in the metal layer area which the first plating resist is removed among the areas of the metal layer 13 formed in the step S120 and the inner plating layer 121 formed in the step S110 in order for the inner plating layers 121 formed on each metal layers 13 to be embedded from the top surface and the bottom surface of the insulating material 110.

Thus, after processing the step S130 of forming the insulating material, as shown in FIG. 6, the inner plating layer 121 may include a first inner plating layer 121-1 embedded from the bottom surface of the insulating material 110 and a second inner plating layer 121-2 embedded from the top surface of the insulating material 110, through this, a composition of a coil pattern embedded inside the insulating material 110 can be formed.

Eventually, by following the manufacturing method in accordance with the embodiment of the present invention, the inner plating layer 121 of the coil pattern can be embedded inside the insulating material 110, the whole thickness can be minimized in comparison with a coil unit to form the plating layers of the coil pattern on a top surface and a bottom surface of the insulating material. Thus, it is possible to achieve miniaturization and slimming of a thin film inductor including the plate layer.

Meanwhile, at least one of the first inner plating layer 121-1 and the second inner plating layer 121-2 embedding inside each of the top surface and the bottom surface of the insulating material 110 may be formed of a plurality of plating layers (not shown) in the step S110. In the case of forming the inner plating layers of the coil pattern of the plurality of layers, the cross-sectional area of the coil pattern may be adjusted and formed; and the degree of freedom of designing the characteristics of the thin film inductor such as the impedance can be improve through this.

Also, the insulating material in the step S110 may be formed from a mixture of Prepreg (PPG) and resin or formed from a type of resin, but it is not limited thereto. Any substance is possible if it can protect by insulating the embedded plating layer 121 therein.

Thus, for the insulating material 110, a variety of applications can be allowable, such as forming a mixture of at least one or two substances selected from a group of Acrylic polymer, Phenolic polymer, and Polyamide polymer.

Also, although the insulating material 110 in accordance with the embodiment of the present invention, as shown in FIG. 6, may be formed in a single insulating layer structure, but it is not limited thereto and a double insulating layer structure of different substances can be adopted. In this case, an insulating material embedding the first inner plating layer 121-1 on the bottom surface thereof and an insulating material embedding the second inner plating layer 121-2 on the top surface thereof may be formed of two different substances.

Like the above, if the insulating material with a double insulating layer structure of different substances is adopted, the thickness can be easily adjusted in comparison with a single insulating layer structure, the insulation distance between the coil pattern and a magnetic substance as well as the distance of the coil may be easily adjusted. Thus, capacitance characteristics of the thin film inductor may be freely designed and formed.

Meanwhile, after processing the step S130 of forming the insulating material, a via-hole may be formed to electrically connect each coil pattern and an outer circuit pattern. Then a conductive via-hole (not shown) can be formed by plating with a process such as De-smear and chemical copper. At this time, although the via-hole is processed through mechanical methods, lasers, or Photo-lithographical processes, but it is not limited thereto.

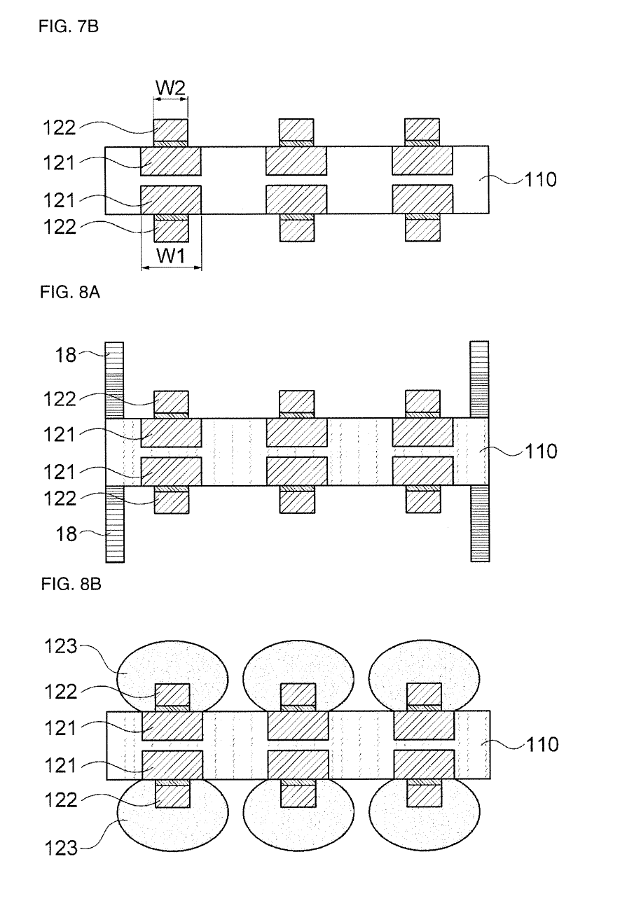

FIG. 7A and FIG. 7B are cross-sectional views showing a step S140 of forming the growth conductive layer of FIG. 2

As shown in FIG. 2, FIG. 7A, and FIG. 7B, the step S140 of forming the growth conductive layer may include forming a second plating resist on the pair of metal layers on the top surface and the bottom surface of the insulating material and then exposing a region including a part or a whole area where the inner plating layer is formed among the regions of the metal layers (S141), forming the growth conductive layer on the exposed area of the metal layer from the step S141 (S142) and exposing a predetermined region of the insulating material by removing the second plating resist and the metal layer placed therebelow (S143).

More specifically, the step S140 of forming the growth conductive layer in accordance with the embodiment of the present invention, as shown in FIG. 7A, the second plating resist 16 may be formed on the pair of metal layers 13 placed on the top and the bottom surfaces of the insulating material 110 to expose the predetermined region of which the inner plating layers 121 are formed among the region of the metal layers 13 (S141).

In the embodiment of the present invention, although the area A, among the areas of the metal layers 13, including the areas of which the inner plating layers are formed is exposed through the second plating resist 16, but it is not limited thereto; accordingly, an area including the whole area formed by the inner plating layer 121 may be exposed.

At this time, similar to the first plating resist 14 of the step S111, as the second plating layer 16, a Dry Film Resist may be used, but it is not limited thereto, any type of resist pattern to form the growth conductive layer 122 described further on can be used, for example, a photoresist.

In addition, as shown in FIG. 7B, the growth conductive layer 122 can be formed (S142) by filling the exposed area (area where the second plating resist has not been formed) of the step S141 with a conductive substance by electroplating using the metal layer 13 as an electrode.

Also, by removing the second plating resist 16 with a process such as exposure, development or the like, as shown in FIG. 7B, the predetermined region of the insulating material 110 can be exposed (S143) by removing the metal layer 13 below the second plating resist 16 through a process such as etching.

According to the step S140 of forming the growth conductive layer in accordance with the present invention, the growth conductive layer 122 can be formed on the inner plating layer 121. Thus, as shown in FIG. 7B, a bonding between two conductors can be formed across the top surface and the bottom surface of the insulating material 110, these bonding can improve the bonding strength of the insulating material and the conductors in comparison with a conventional bonding structure. Thus, in case when the growth conductive layer 122 is formed on the inner plating layer 121 as like the embodiment of the present invention, the delamination of patterns between the insulating material 110 and the coil pattern 120 can be prevented.

In addition, according to the step S140 of forming the growth conductive layer in accordance with the embodiment of the present invention, when the growth conductive layer 122 is formed on the inner plating layer 121, the conductors are bonded to each other across the top surface and the bottom surface of the insulating material 110, the surface of the plating may be formed much wider, thus improving the degree of freedom of designing the characteristics of the thin film inductor such as the impedance.

Meanwhile, in the step S140 of forming the growth conductive layer in accordance with the embodiment of the present invention, as shown in FIG. 7A and FIG. 7B, depending on the area A exposed by the second plating resist 16, the width W2 of the growth conductive layer 122 may be formed smaller than the width Al of the inner plating layer 121. This is because, as described above, if the width W2 of the growth conductive layer 122 is larger or equal to the width W1 of the inner plating layer 121, a short circuit may occur between the adjoining outer plating layers 123 when the outer plating layer 123 is formed by a process such as anisotropic plating. However, the present invention is not limited thereto; and, therefore, when the outer plating layer 123 is formed by a process such as anisotropic plating, the width W2 of the growth conductive layer 122 may be larger or equal to the width W1 of the inner plating layer 121.

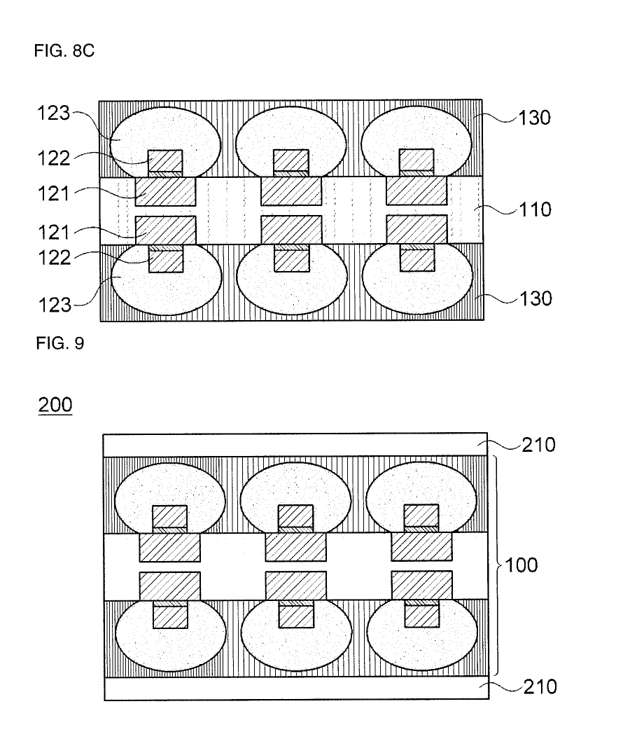

FIG. 8A to FIG. 8C are cross-sectional views showing steps S150 and S160 of forming the outer plating layer and the insulation resist of FIG. 2.

First, the step S150 of forming the outer plating layer in accordance with the embodiment of the present invention may include, as shown in FIG. 2, FIG. 8A and FIG. 8B, forming a third plating resist on a part or a whole area of the exposed insulating material from the step S143, and then exposing the growth conductive layer 122 (S151), forming the outer plating layer by plating and growing based on the exposed growth conductive layer from the step S151 (S152), and removing the third plating resist (S153).

More specifically, in the step S150 of forming the outer plating layer in accordance with the embodiment of the present invention, the growth conductive layer 122 (S151) can be exposed by forming the third plating resist 18 on the region of the insulating material 110 exposed in the step S143.

As shown in FIG. 8A and FIG. 8B, in order for the anisotropic plating of the outer plating layer 123 or the like, the third plating resist 18 is formed on a part of the region of the insulating material 110 exposed in the step S143. However, it is not limited thereto, if the outer plating layer 123 is formed by unidirectional plating as such, the third plating resist 18 may be formed on the whole region of the insulating material 110 exposed in the step S143.

At this time, as like the first plating resist 14 and the second plating resist 16 of the steps S111 and S141, Dry Film Resist may be used for the third plating resist 18, but it is not limited thereto. Any type of resist pattern, e.g., a photoresist or the like, to form the outer plating layer 123 described further on can be used.

In addition, as shown in FIG. 8B, the outer plating layer 123 can be formed by performing electroplating using the growth conductive layer 122 as a base electrode and growing this (S152).

Also, by removing the third plating resist 18 with a process such as exposure, development or the like (S153), the outer plating layer 123 can be formed on each of the top surface and the bottom surface of the insulating material 110, respectively.

At this time, although the outer plating layer 123, as shown in FIG. 8B, may be formed by anisotropic plating, but it is not limited thereto, as well as the outer plating layer 123 may be formed by other processes such as unidirectional plating.

Next, the method for manufacturing a coil unit for a thin film inductor in accordance with another embodiment of the present invention, as shown in FIG. 2 and FIG. 8C, a step S160 of forming an insulation resist may be further included after the step S150 of forming the outer plating layer.

That is, as shown in FIG. 8C, a solder resist 130 may be formed on the top surface and the bottom surfaces of the insulating material 110 and the outer plating layer 123 for insulation. However, the present invention is not limited thereto, the solder resist 130 may be formed along the surface of the outer plating layer 123 and any insulating resist which can protect the exposed area of the outer plating layer 123 may be used.

### Method for Manufacturing Thin Film Inductor

FIG. 9 is a schematic cross-sectional view of a thin film inductor 200 in accordance with another embodiment of the present invention.

Referring to FIG. 9, a thin film inductor 200 in accordance with the embodiment of the present invention may be formed by including the magnetic substance 210 attached to the coil unit 100 for thin film inductor 200

At this time, in the embodiment of the present invention, the magnetic substance 210 attached on both of the top surface and the bottom surface of the coil unit 100 for thin film inductor 200 is shown as an example, but it is not limited thereto, the thin film inductor 200 may be formed by attaching the magnetic substance 210 only the top surface or the bottom surface of the coil unit 100 for the thin film inductor.

At this time, when the magnetic substance 210 is bonded to the coil unit 100 for thin film inductor, they can be bonded by using polymer such as epoxy, polyimide or the like or by utilizing the other adhesives.

Also, for the magnetic substance 210, a conventional ferrite powder may be used as it is or the ferrite formed on the glass or the other substrates may be used as the magnetic substance as well as the soft magnetic film formed by a thin film process or a laminate of an insulating material film may be used.

Meanwhile, the thin film inductor 200 shown in FIG. 9 may include the coil unit 100 for the thin film inductor 200 formed in accordance with the manufacturing method of the embodiment of the present invention, that is, the step of forming the coil unit 100 for thin film inductor shown in FIG. 1; and, then attaching the magnetic substance 210 on at least one of the top surface and the bottom surface of the coil unit 100 for the thin film inductor.

In accordance with the embodiments of the present invention, the miniaturization and the slimness can be allowable as well as the delamination of patterns can be prevented.

And also, in accordance with the embodiments of the present invention, the characteristics of the thin film can be designed more freely as well as the mass production can be achieved by simplifying the manufacturing process.

The foregoing description illustrates the present invention. Additionally, the foregoing description shows and explains only the preferred embodiments of the present invention, but it is to be understood that the present invention is capable of use in various other combinations, modifications, and environments and is capable of changes and modifications within the scope of the inventive concept as expressed herein, commensurate with the above teachings and/or the skill or knowledge of the related art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

1. A coil unit for a thin film inductor comprising:
an insulating material and a coil pattern,
wherein the coil pattern includes:
an inner plating layer embedded in the insulating layer;
a growth conductive layer formed on a surface of the inner plating layer and formed on a top surface and a bottom surface of the insulating layer; and
an outer plating layer formed on the top surface and the bottom surface of the insulating material by plating and growing based on the growth conductive layer.

2. The coil unit for the thin film inductor according to claim 1, wherein the inner plating layer includes:
a first inner plating layer embedded from the bottom surface of the insulating material; and
a second inner plating layer embedded from the top surface of the insulating layer.

3. The coil unit for the thin film inductor according to claim 2, wherein at least one of the first and the second inner plating layers is formed of a plurality of plating layers.

4. The coil unit for the thin film inductor according to claim 1, wherein the outer plating layer is formed by anisotropic plating.

5. The coil unit for the thin film inductor according to claim 1, wherein the outer plating layer is formed by unidirectional plating.

6. The coil unit for the thin film inductor according to claim 1, wherein a width of the growth conductive layer is smaller than a width of the inner plating layer.

7. The coil unit for the thin film inductor according to claim 1, wherein further comprises:
an insulating resist formed on the top surface and the bottom surface of the insulating material and the outer plating layer.

8. The coil unit for the thin film inductor according to claim 1, further comprises:
an insulating resist formed along a surface of the outer plating layer.

9. A thin film inductor comprising:
the coil unit for the thin film inductor described in claim 1; and
a magnetic substance attached on at least one of a top surface and a bottom surface of the coil unit for the thin film inductor.

10. A method for manufacturing a coil unit for a thin film inductor comprising:
forming an inner plating layer in a pair of metal layers attached on both surfaces of a base layer by an adhesive layer;
separating the pair of metal layers from the base layer;
forming an insulating material in such a way that the inner plating layer formed on each of the pair of separated metal layers is embedded;
forming a growth conductive layer on a top surface and a bottom surface of the insulating material and on the inner plating layer; and
forming an outer plating layer on the top surface and the bottom surface of the insulating layer by plating and growing based on the growth conductive layer.

11. The method for manufacturing the coil unit for the thin film inductor according to claim 10, wherein forming the inner plating layer includes:
exposing a predetermined region of the metal layer by forming a first plating resist corresponding to the inner plating layer on each of the pair of metal layers;
forming the inner plating layer on the exposed region of the metal layers; and
removing the first plating resist.

12. The method for manufacturing the coil unit for the thin film inductor according to claim 11, wherein forming the insulating material forms the insulating material on the inner plating layer and the metal layer which the first plating resist is removed in such a way that the inner plating layers formed on each of the pair of the metal layers are embedded from the top surface and the bottom surface of the insulating material.

13. The method for manufacturing the coil unit for the thin film inductor according to claim 12, wherein the inner plating layer includes:
a first inner plating layer which is embedded from the bottom surface of the insulating material; and
a second inner plating layer which is embedded from the top surface of the insulating material.

14. The method for manufacturing the coil unit for the thin film inductor according to claim 13, wherein at least one of the first and the second inner plating layer is formed of a plurality of plating layers.

15. The method for manufacturing the coil unit for the thin film inductor according to claim 12, wherein forming the growth conductive layer includes:
exposing a region including a part or a whole region of an area where the inner plating layer is formed among a region of the metal layer by forming a second plating resist on the pair of metal layers in a top surface and a bottom surface of the insulating material;
forming the growth conductive layer on the exposed region of the metal layer; and
exposing a predetermined region of the insulating layer by removing the second plating resist and the metal layer placed therebelow.

16. The method for manufacturing the coil unit for the thin film inductor according to claim 15, wherein forming the outer plating layer includes:
exposing the growth conductive layer by forming a third plating resist on a part or a whole area of the exposed insulating material;
forming the outer plating layer by plating and growing based on the exposed growth conductive layer; and
removing the third plating resist.

17. The method for manufacturing the coil unit for the thin film inductor according to claim 10, wherein, in forming the outer plating layer, the outer plating layer is formed by anisotropic plating.

18. The method for manufacturing the coil unit for the thin film inductor according to claim 10, wherein, in forming the outer plating layer, the outer plating layer is formed by unidirectional plating.

19. The method for manufacturing the coil unit for the thin film inductor according to claim 10, wherein, in forming the growth conductive layer, a width of the growth conductive layer is smaller than that of the inner plating layer.

20. The method for manufacturing the coil unit for the thin film inductor according to claim 10, after forming the outer plating layer, further comprises:
forming an insulating resist on the top surface and the bottom surface of the insulating material and the outer plating layer.

21. The method for manufacturing the coil unit for the thin film inductor according to claim 10, after forming the outer plating layer, further comprises:
forming an insulating resist along a surface of the outer plating layer.

22. A method for manufacturing a thin film inductor comprising:
bonding a magnetic substance on at least one of a top surface and a bottom surface of a coil unit for a thin film inductor formed according to the method for manufacturing the coil unit for the thin film inductor described in claim 10.
